(19) United States
(12) Patent Application Publication
(10) Pub. No.: US 2004/0188150 A1
(43) Pub. Date: Sep. 30, 2004

(54) High transparency touch screen

(75) Inventors: James T. Richard, Lake Elmo, MN (US); William K. Smyth, Stillwater, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/395,964

(22) Filed: Mar. 25, 2003

(51) Int. Cl. G06K 11/06

(52) U.S. Cl. 178/18.01

(57) ABSTRACT

A touch sensor employs one or more transparent conductors incorporating a random pattern of voids. The voids are arranged according to a random pattern that maintains the electrical continuity of the transparent conductive layer. The touch sensor is manufactured by depositing a layer of a transparent conductor and forming voids in the transparent conductor. Formation of the voids may be used to achieve a selected sheet resistance of the conductive layer as well as to improve optical transmission through the touch sensor.

### BACKGROUND

A touch screen offers a simple, intuitive interface to a computer or other data processing device. Rather than using a keyboard to type in data, a user can transfer information through a touch screen by touching an icon or by writing or drawing on a screen. Touch screens are used in a variety of information processing applications, and have been found to be particularly useful in interactive systems that also include a computer-controlled display. Touch screens are used in applications such as mobile phones, personal data assistants (PDAs), handheld or laptop computers, as well as publicly located information kiosks, automatic teller machines, and point-of-sale terminals.

Various technologies have been developed to sense touch, including capacitive, resistive, acoustic, and infrared techniques. Resistive technologies typically detect touch by sensing a change in an electrical signal caused by contact between two transparent conductive layers. The resistive touch sensor may be energized by the application of a drive signal from a controller coupled to one or more of the conductive layers. A touch applied to the surface of the resistive touch sensor deflects a first flexible, conductive layer, causing the first conductive layer to make contact with the second conductive layer. Contact between the first and second conductive layers causes a change in a sensed electrical signal. The location of the touch is determined as a function of the point of contact between the conductive layers.

A touch on the surface of a capacitive touch sensor changes the impedance of the touch sensor circuit at the touch location, and causing a change in an applied electrical signal. For example, an AC signal may be applied to electrodes positioned at four corners of a transparent, conductive layer of the capacitive touch sensor. A finger touch on the touch sensor surface capacitively couples the touch sensor to ground. The capacitively coupled circuit alters the impedance, which produces a change in a sensed electrical signal. The change in the electrical signal is detected at each electrode, and the relative change in the signal at each electrode is used to determine touch position.

Both resistive and capacitive touch sensors may make use of thin film electrodes formed of a transparent metal oxide. The optical and electronic properties of metal oxide films are strongly interrelated.

### SUMMARY OF THE INVENTION

According to one embodiment, a touch sensor includes a transparent conductive layer coupled to a transparent insulating layer. The transparent conductive layer incorporates an intended plurality of voids arranged according to a random pattern. The voids are arranged to maintain the electrical continuity of the transparent conductive layer.

Another embodiment of the invention involves a method for manufacturing a high transparency touch sensor. A transparent conductive layer is disposed on a substrate. Voids are formed in the transparent conductive layer according to a random pattern.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### BRIEF DESCRIPTION OF THE DRAWINGS

FIG. 1A is a diagram illustrating a high transparency resistive touch sensor in accordance with an embodiment of the invention;

FIG. 1B is a diagram illustrating a high transparency capacitive touch sensor in accordance with an embodiment of the invention;

FIG. 1C is a diagram of a transparent conductive layer incorporating voids arranged in a random pattern in accordance with an embodiment of the invention;

FIG. 2 is a block diagram of a touch sensing system using a high transparency touch sensor in accordance with an embodiment of the invention; and

FIG. 3 is a flowchart illustrating a method for manufacturing a high transparency touch sensor in accordance with an embodiment of the invention;

While the invention is amenable to various modifications and alternative forms, specifics thereof have been shown by way of example in the drawings and will be described in detail. It is to be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF VARIOUS EMBODIMENTS

In the following description of the illustrated embodiments, reference is made to the accompanying drawings which form a part hereof, and in which is shown by way of illustration, various embodiments in which the invention may be practiced. It is to be understood that the embodiments may be utilized and structural changes may be made without departing from the scope of the present invention.

The present invention is directed to methods and systems for enhancing optical transmission through touch sensors using transparent conductive elements. Resistive and capacitive touch sensing methodologies, for example, typically incorporate transparent conductors as active elements of the touch sensor device. The transparent conductive oxide most widely used in these applications is indium tin oxide (ITO), although other metal oxides, such as antimony tin oxide (ATO) and tin oxide (TO) are also used. Metal/metal oxide stacks can also be used, for example employing a very thin metal layer on top of a metal oxide layer or between the substrate and a metal oxide layer. It is also possible to use organic conductors such as conductive polymers.

A desired sheet resistance of the transparent conductive layer may be achieved during deposition by maintaining a selected material thickness. However, depositing a relatively thin layer of metal oxide to achieve a high sheet resistance and high optical transmission may present challenges with regard to maintaining a uniform layer thickness. The various embodiments of the invention involve touch sensing devices and methods of manufacturing touch sensing devices having both high transparency and high sheet resistance.

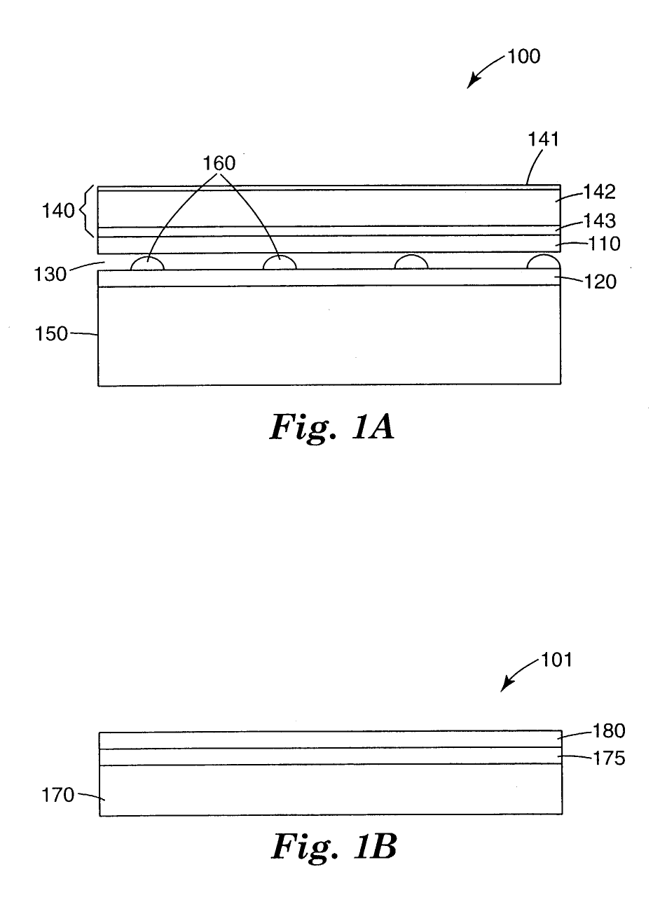

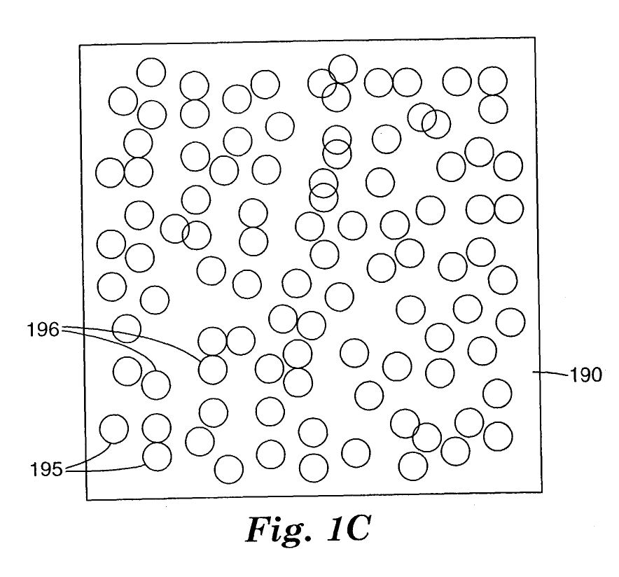

FIG. 1A illustrates a resistive touch sensor 100 in accordance with one embodiment of the invention. The resistive touch sensor 100 shown in FIG. 1A includes a top substrate 140 that forms the touch surface of the sensor 100. Top substrate 140 is preferably formed of a material that is dimensionally stable and resistant to abrasion and chemicals. In one configuration, a base layer 142 comprising a polyester material, such as polyethylene terephthalate (PET) is used as a component of the top substrate 140. The top substrate 140 may optionally incorporate one or more additional layers 141, 143, such as hard coats to improve the structural characteristics and scratch resistance of the top layer as well as antireflective or antiglare coatings to improve viewability through the touch sensor.

The touch sensor 100 includes first and second conductive layers 110, 120 separated by a gap 130. The first conductive layer 110 is disposed on the top layer 140, which may optionally incorporate a number of layers, such as hardcoat layers and/or antireflective or antiglare coatings as described above. A substrate layer 150, comprised of a suitable transparent material, such as glass or plastic, supports the second conductive layer 120. One or more spacers 160 may be positioned within the gap layer 130 to maintain an appropriate spacing between the conductive layers 110, 120. The conductive layers 110, 120 may be formed, for example, by depositing a transparent conductive metal oxide layer, such as ITO, ATO, TO, or other transparent conductive materials on the top layer 140 and substrate 150.

The resistive touch sensor 100 may be energized by an electrical drive signal produced by controller circuitry (not shown) and applied to one or more of the conductive layers 110, 120 of the resistive touch sensor. A touch applied to the surface of the touch sensor 100 deflects the first conductive layer 110 towards the second conductive layer 120, causing the contact between the conductive layers 110, 120. The location of the touch is determined as a function of the point of contact between the conductive layers 110, 120.

The controller may alternate the electrical signal between the first and second conductors 110, 120 to determine the x and y coordinates of the touch. Alternatively, one of the conductors can be driven from all four corners, for example, while the other is held at ground or another constant potential.

FIG. 1B illustrates a capacitive touch sensor 101 in accordance with an embodiment of the invention. In this example, a conductive layer 175 is formed on a transparent substrate 170 of a suitable material, such as glass or plastic. As previously discussed, the transparent conductive layer may be formed of a transparent metal oxide, such as ITO, ATO, or TO.

A controller (not shown) is coupled to the conductive layer 175 and provides an electrical drive signal to the conductive layer 175. Optionally, a resistor pattern may be screen printed on the conductive layer 175 to linearize the electric field supplied by the touch sensor controller across the surface of the touch sensor 101. In this example, a dielectric layer 180 is coupled to the conductive layer 175. The dielectric layer 180 may incorporate several layers including one or more layers to protect the touch sensor and/or reduce glare, for example.

FIGS. 1A and B illustrate examples of resistive and capacitive touch sensors incorporating transparent layers. Other configurations of touch sensors employing transparent conductive layers are also possible and are considered to be within the scope of the invention.

The high index of refraction of the metal oxide to air interface causes a significant reduction in light transmitted from a display through the transparent touch sensor. Also, metal oxide transparent conductors tend to absorb visible light preferentially in the blue region of the spectrum, resulting in a yellowed appearance, especially in thicker layers. High temperature annealing may improve the optical properties of the metal oxide, but may also result in a lower than desired sheet resistance, or may not be possible due to the temperature sensitivity of other layers or materials present (for example, use of a polymeric substrate).

Touch sensors arranged according to the various embodiments of the invention improve the optical transmission of the touch sensor by removing selected areas of one or more of the conductive layers of the touch sensor. Removal of the conductive material increases the optical transmission through the touch sensor.

Furthermore, a desired sheet resistance of the metal oxide layer may be achieved during deposition by maintaining a selected material thickness. However, depositing a relatively thin layer of metal oxide to achieve a high sheet resistance may present challenges with regard to maintaining a uniform layer thickness. According the embodiments of the invention, a thicker layer of material may be initially deposited, thus mitigating uniformity problems that may be associated with the deposition of thin layers. The sheet resistance of the relatively thick layer is increased to the desired value by removing selected areas of the conductive layer, which also increases optical transmission through the conductive layer.

FIG. 1C illustrates a conductive layer configured in accordance with an embodiment of the invention. A conductive layer arranged as illustrated in FIG. 1C may be used to form the conductive layer 175 of the capacitive touch sensor 101 illustrated in FIG. 1B. One or both conductive layers 110, 120 of the resistive touch sensor 100 illustrated in FIG. 1A may be configured as illustrated FIG. 1C.

The conductive layer 190 shown in FIG. 1C incorporates a number of voids 195, 196 arranged randomly over the conductive layer 190. The voids 195, 196 may define apertures 195 through the conductive material or they may form craters 196 wherein the conductive material is only partially penetrated by the crater 196. The voids may optionally penetrate into or through layers adjacent to the conductive layer. The random pattern of voids 195, 196 creates a stochastic screen, resulting in little or no formation of moiré interference patterns.

The voids 195, 196, which are shown as substantially circular in FIG. 1C, may be any shape. In one example, each void 195, 196 defines an area less than about 10,000 μm². The density of the voids 195, 196 is selected to maintain the physical and electrical continuity of the conductive layer 190 and to achieve a desired sheet resistance, for example, a sheet resistance in the range of about 100 to 2000 ohms/square for resistive touch sensors, or 200 to 10,000 ohms/square for capacitive touch sensors, although other sheet resistances may be achieved as desired. The size and density of the voids may also be selected to achieve desired visual properties, such as a uniform appearance when a display is viewed through a touch screen incorporating a transparent conductive film containing such voids.

The touch sensor described in connection with FIG. 1 may be used in a touch sensing system incorporating a controller. The controller provides energizing signals to the touch sensor and interprets signals from the touch sensor to determine a touch location. The touch sensor and controller together may be combined with a processor and/or a display.

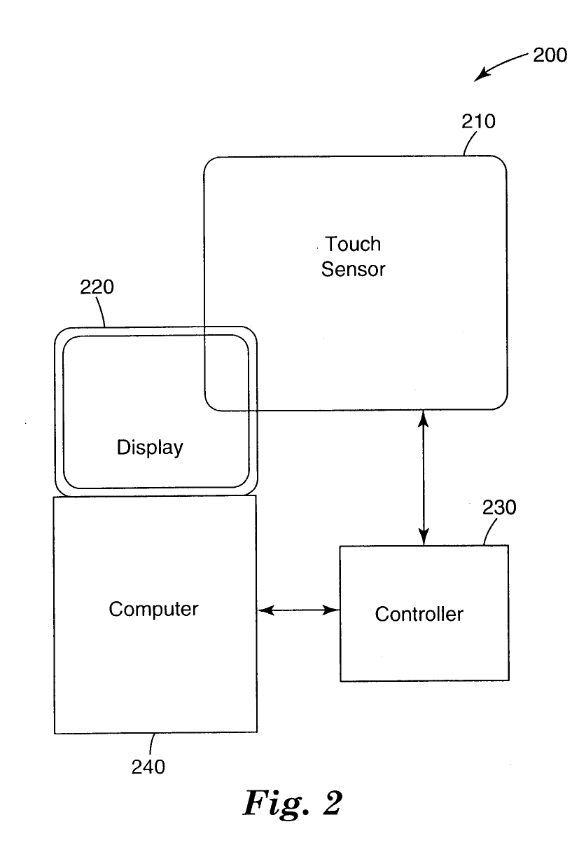

Turning now to FIG. 2, there is shown an embodiment of a touch sensing system 100 using a high transparency etched touch sensor in accordance with an embodiment of the present invention. The touch sensing system 200 shown in FIG. 1 includes a touch sensor 210 that is communicatively coupled to a controller 230. In a typical configuration, the touch sensor 210 is used in combination with a display 220 of a computer system 240 to provide for visual and/or tactile interaction between a user and the computer system 240. The touch sensor 210 and the display 220 may be arranged so that the display 220 is viewable through the touch sensor 210.

The touch sensor 210 can be implemented as a device separate from, but operative with, the display 220 of the computer system 240. Alternatively, the touch sensor 210 can be implemented as part of a unitary system which includes a display device, such as a light emitting diode display, a cathode ray tube display, a plasma display, a liquid crystal display, an electroluminescent display, static graphics, other type of display technology amenable to incorporation of the touch sensor 210. It is further understood that the touch sensor 210 may be implemented as a component of a system defined to include only the touch sensor 210 and the controller 230 which, together, can implement a touch system of the present invention.

In the illustrative configuration shown in FIG. 2, communication between the touch sensor 210 and the computer system 240 is implemented via the controller 230. The controller 230 is typically configured to execute firmware/software that provides for detection of touches applied to the touch sensor 210. The controller 230 may alternatively be arranged as a component of the computer system 240.

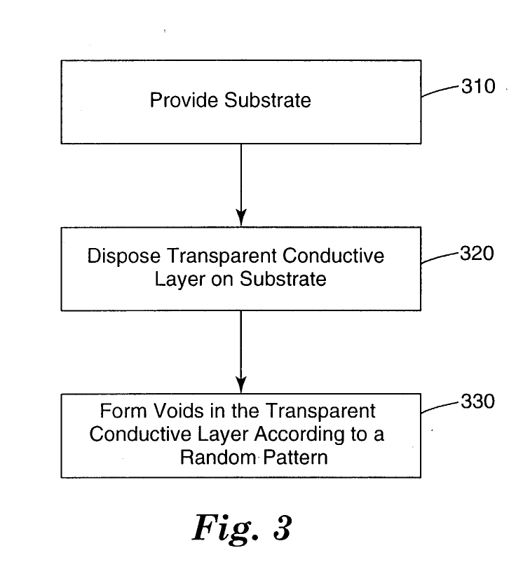

A method for manufacturing a high transparency touch sensor in accordance with an embodiment of the invention is illustrated in the flowchart of FIG. 3. According to this method, a substrate is provided 310. A transparent conductive layer is disposed 320 on the substrate. Voids are formed 330 in the transparent conductive layer according to a random pattern. The density of the voids is selected to maintain the electrical continuity of the conductive layer.

In one embodiment, the transparent conductive layer is comprised of a conductive oxide such as ITO, ATO or TO. The voids may define apertures through the conductive layer or may form craters wherein the conductive layer is only partially penetrated by the void. The voids may be substantially circular, as illustrated in FIG. 1C, may be any shape. In one example, each void defines an area less than about 10,000 μm².

The voids are formed so that their density and arrangement maintains the physical and electrical continuity of the conductive layer and may be used to achieve a desired sheet resistance. In one example, a low sheet resistance film is deposited and the selected areas of the film are removed to achieve the desired sheet resistance. For sake of non-limiting example, a conductive film having a sheet resistance in the range of about 5 to 10 ohms/square may be deposited. Voids are formed in the conductive film to achieve a desired sheet resistance, for example, a sheet resistance in the range of about 300 to 500 ohms/square. In some applications, the size, density, and arrangement of the voids may be selected so that the surface of the touch sensor presents an acceptably uniform appearance.

According to one embodiment, the voids are formed in a random pattern by laser ablation. The conductive layer can be directly ablated, or ablation may be enhanced or assisted by disposing a “blow-off” layer between the conductive layer and the substrate or on top of the conductive layer. The “blow-off” layer is formed of a material suitable for absorbing laser radiation to facilitate the formation of the voids. Suitable ablation assisting or enhancing layers include metals and other materials such as disclosed in U.S. Pat. No. 6,485,839.

In another embodiment, formation of the voids is accomplished by selective etching. The etchant resist may be patterned on the conductive layer using photolithographic techniques, ink jet printing or other patterning methods. Alternatively, an etchant may be selectively deposited directly via printing techniques.

According to yet another embodiment, particles of appropriate size are randomly deposited on the substrate. A conductive material is deposited on the substrate so that the conductive material surrounds the particles, forming an electrically continuous conductive layer. The particles are removed from the substrate leaving voids in the conductive layer. The conductive material may be back etched to expose the particles for removal.

In addition to the substrate and conductive layer, a method for manufacturing a touch sensor in accordance with an embodiment of the invention may further include the formation of one or more dielectric layers and/or protective layers coupled to the transparent conductive layer and the substrate.

A process of manufacturing a capacitive touch sensor may further include forming a protective layer over the conductive layer containing the voids. A sufficiently thin protective layer may conform to the structure created by the voids, thus providing a roughened surface. Such a roughened protective layer may be useful for providing anti-glare properties, provided the depth of the voids is sufficient so that the coated protective layer has a surface roughness sufficient for reducing glare. Surface roughnesses of around 100 nm may be sufficient for reducing glare. If the conductive layer itself is not thick enough to allow formation of sufficiently deep voids, an additional layer or layers may be disposed on the conductive layer or between the conductive layer and the substrate. Voids can then be formed that penetrate both the conductive layer and the additional layer(s) so that a desirable depth is achieved.

A process for manufacturing a resistive touch sensor may further include forming a second transparent conductive layer separated by a gap from the first transparent conductive layer. Randomly arranged voids may be formed in the second transparent conductive layer.

The foregoing description of the various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A touch sensor, comprising:
a transparent conductive layer coupled to a transparent insulating layer, the transparent conductive layer incorporating an intended plurality of voids arranged according to a random pattern and maintaining electrical continuity of the transparent conductive layer.

2. The touch sensor of claim 1, wherein at least some of the voids define apertures through the transparent conductive layer.

3. The touch sensor of claim 1, wherein at least some of the voids do not define apertures through the transparent conductive layer.

4. The touch sensor of claim 1, wherein each void has an area less than about 10,000 μm².

5. The touch sensor of claim 1, wherein the voids are substantially circular.

6. The touch sensor of claim 1, wherein the transparent conductive layer incorporating the voids has a sheet resistance in a range of about 100 to 10,000 ohms per square.

7. The touch sensor of claim 1, wherein the touch sensor comprises a capacitive touch sensor.

8. The touch sensor of claim 1, wherein the touch sensor comprises a resistive touch sensor.

9. The touch sensor of claim 1, wherein the transparent conductive layer comprises ITO.

10. The touch sensor of claim 1, wherein the transparent conductive layer comprises ATO.

11. The touch sensor of claim 1, wherein the transparent conductive layer comprises TO.

12. The touch sensor of claim 1, wherein the transparent conductive layer comprises a conductive polymer.

13. The touch sensor of claim 1, wherein the transparent insulating layer comprises glass.

14. The touch sensor of claim 1, wherein the transparent insulating layer comprises PET.

15. The touch sensor of claim 1, further comprising a controller coupled to the transparent conductive layer and configured to determine a touch input location based on signals associated with the touch input.

16. The touch sensor of claim 15, further comprising a display disposed for viewing through the transparent conductive layer.

17. The touch sensor of claim 16, where the display comprises a liquid crystal display.

18. The touch sensor of claim 17, further comprising a processor coupled to the controller and the display, the processor configured to receive touch location information from the controller and display information on the display.

19. A method of manufacturing a touch sensor, comprising:
disposing a transparent conductive layer on a substrate; and
forming voids in the transparent conductive layer, wherein the voids are arranged according to a random pattern.

20. The method of claim 19, wherein the voids are formed by etching.

21. The method of claim 19, wherein the voids are formed by ablation.

22. The method of claim 19, wherein the voids are arranged to maintain electrical continuity of the transparent conductive layer.

23. The method of claim 19, wherein forming the voids comprises forming substantially circular voids.

24. The method of claim 19, wherein the voids have an area in a range of about 10,000 μm².

22. The method of claim 19, wherein the voids define apertures through the conductive layer.

22. The method of claim 19, wherein the voids do not penetrate the conductive layer.

23. The method of claim 19, wherein forming the voids comprises forming the voids to achieve a selected sheet resistance of the transparent conductive layer.

24. The method of claim 19, wherein the selected sheet resistance is in a range of about 100 to 10,000 ohms/square.

25. The method of claim 19, further comprising disposing a radiation absorbing layer between the transparent conductive layer and the substrate, and ablating the transparent conductive layer to form the voids using radiation absorbed by the radiation absorbing layer.

26. The method of claim 19, wherein disposing the transparent conductive layer on the substrate comprises depositing particles on the substrate and forming the transparent conductive layer surrounding the particles and forming the voids comprises removing the particles.
